(19) United States
(12) Patent Application Publication
(10) Pub. No.: US 2009/0120535 A1
(43) Pub. Date: May 14, 2009

(54) METHOD OF BONDING STEEL MEMBERS, METHOD OF ENHANCING BONDING STRENGTH OF UNITED BODY FORMED OF STEEL MEMBERS, STEEL PRODUCT, AND DIE-CAST PRODUCT

(75) Inventors: Toshiaki Kitazawa, Nagano (JP); Takayuki Fujimori, Nagano (JP)

Correspondence Address: LOWE HAUPTMAN HAM & BERNER, LLP, 1700 DIAGONAL ROAD, SUITE 300, ALEXANDRIA, VA, 22314, US

(73) Assignee: MOLE'S ACT CO., LTD., Nagano (JP)

(21) Appl. No.: 12/293,225

(22) PCT Filed: Mar. 16, 2006
(86) PCT No.: PCT/JP2006/305296

§ 371 Date: Sep. 16, 2008

(51) Int. Cl. C22C 38/00; C21D 9/50; B23K 31/02

(52) U.S. Cl. 148/320; 148/529; 228/178

(57) ABSTRACT

The present invention provides a method of bonding steel members by bonding a plurality of steel members made of a Cr-containing steel material to each other. The method includes a united body forming step S10 in which a united body is formed by making the plurality of steel members butted to each other and by heating the plurality of steel members to a first temperature while pressing the plurality of steel members under a predetermined pressure condition; and a bonding strength enhancing step S30 in which the united body is heated to a second temperature equal to or above an A₁ transformation point of the steel material and, subsequently, is gradually cooled to a third temperature equal to or below 600° C. under a condition that lowering of temperature to 600° C. from A₁ transformation point takes 10 hours or more in this order. According to the method of bonding steel members of the present invention, even when the united body is manufactured by bonding the plurality of steel members made of a Cr-containing steel material to each other, the united body can acquire a sufficiently high bonding strength.

### RELATED APPLICATIONS

The present application is based on, and claims priority from, International Application Number PCT/JP2006/305296, filed Mar. 16, 2006, the disclosure of which is hereby incorporated by reference herein in its entirety.

### TECHNICAL FIELD

The present invention relates to a method of bonding steel members, a method of enhancing a bonding strength of a united body formed of steel members, a steel product, and a die-cast product.

### BACKGROUND ART

FIG. 7 is a flowchart for explaining a conventional method of bonding steel members, and FIG. 8 is a view for explaining the conventional method of bonding steel members.

As shown in FIG. 7 and FIG. 8, the conventional method of bonding steel members includes a united body forming step S910 in which, a united body is formed by bonding a plurality of steel members by heating a plurality of steel members at a temperature which enables bonding of the plurality of steel members while pressing the plurality of steel members under a predetermined pressure condition in a state that bonding scheduled surfaces of the plurality of steel members are butted to each other, and a bonding strength enhancing step S920 for enhancing a bonding strength of steel members of the united body by applying heat treatment to the united body under a predetermined temperature condition (see patent document 1, for example).

In this manner, according to the conventional method of bonding steel members, it is possible to bond the plurality of steel members using no auxiliary material for welding. Further, according to the conventional method of bonding steel members, by performing the bonding strength enhancing step S920 after the formation of the united body, a bonding strength of the united body can be enhanced.

As a result, according to the conventional method of bonding steel members, it is possible to manufacture a united body which can be preferably used as a mold for producing resin products such as plastic gears.

Patent document 1: JP-A-2002-59270

### DISCLOSURE OF THE INVENTION

### Problems to be Solved by the Invention

However, it has been found that the conventional method of bonding steel members has a drawback that when a united body is manufactured by bonding a plurality of steel members made of a Cr-containing steel material (die steel such as SKD61, for example), the united body cannot acquire a sufficiently high bonding strength.

The present invention has been made to overcome the above-mentioned drawback, and it is an object of the present invention to provide a method of bonding steel members which enables the united body to acquire a sufficiently high bonding strength even when a united body is manufactured by bonding a plurality of steel members made of a Cr-containing steel material to each other.

Further, it is another object of the present invention to provide a method of enhancing a bonding strength of a united body formed of steel members which enables the united body to acquire a sufficiently high bonding strength even when the united body is manufactured by bonding a plurality of steel members made of a Cr-containing steel material to each other.

It is still another object of the present invention to provide a united body which is formed by bonding using such a method of bonding steel members, and a steel product which is manufactured by using the united body whose bonding strength is enhanced by the method of enhancing a bonding strength of a united body formed of steel members.

It is a further object of the present invention to provide a die-cast product manufactured using a die-cast mold when the steel product is the die-cast mold.

### Means for Solving the Tasks

### Means for Solving the Problems

To achieve the above-mentioned object, inventors of the present invention have investigated a reason why the sufficiently high bonding strength cannot be acquired when the united body is manufactured by bonding the plurality of steel members made of a Cr-containing steel material to each other in the conventional method of bonding steel members. As a result of the investigation, the inventors have found that the insufficient bonding strength is attributed to the presence of a Cr-containing passivation layer on a bonding surface. Based on such finding, the inventors have come up with an idea that the bonding strength can be sufficiently increased by dissipating the Cr-containing passivation layer present on the bonding surface so that the above-mentioned drawback can be overcome, and the inventors have arrived at the present invention.

(1) That is, in a method of bonding steel members of the present invention by bonding a plurality of steel members made of a Cr-containing steel material, the method includes: a united body forming step in which a united body is formed by bonding a plurality of steel members to each other such that bonding scheduled surfaces of the plurality of steel members are butted to each other, and the plurality of steel members are heated to a first temperature which enables bonding of the plurality of steel members while pressing the plurality of steel members under a predetermined pressure condition; and a bonding strength enhancing step in which the bonding strength of the united body is enhanced by heating the united body to a second temperature equal to or above an A₁ transformation point of the steel material and, subsequently, by gradually cooling the united body to a third temperature equal to or below 600° C. under a condition that lowering of temperature to 600° C. from A₁ transformation point takes 10 hours or more thus dissipating a Cr-containing passivation layer present on bonding surfaces of the united body in this order.

Due to such constitution, according to the method of bonding steel members of the present invention, by performing the bonding strength enhancing step after the united body forming step, the Cr-containing passivation layer present on the bonding surface can be dissipated and hence, the bonding strength of the united body can be sufficiently enhanced. As a result, the method of bonding steel members of the present invention becomes a method of bonding steel members which enables the united body to acquire a sufficiently high bonding strength even when the united body is manufactured by bonding the plurality of steel members made of the Cr-containing steel material to each other.

In the method of bonding steel members of the present invention, to sufficiently enhance the bonding strength of the united body by dissipating the Cr-containing passivation layer present on the bonding surface, it is necessary to heat the united body to the second temperature which is equal to or above the A₁ transformation point of the steel material and, thereafter, to gradually cool the united body to the third temperature which is equal to or below 600° C. under the condition that lowering of temperature to 600° C. from the A₁ transformation point takes 10 hours or more. That is, it is necessary to gradually cool the united body to 600° C. from the A₁ transformation point by spending a sufficient time.

By adopting such a method, the Cr-containing passivation layer on the bonding surface is melted in a steel material which forms a mother phase in the course of the transformation of structure along with gradual cooing, and the Cr-containing passivation layer is finally dissipated and hence, the bonding strength of the united body can be sufficiently enhanced.

(2) In the above-mentioned method of bonding steel members (1), it is preferable that the second temperature falls within a range between the A₁ transformation point and a temperature higher than the A₁ transformation point by 100° C.

By adopting such a method, it is possible to dissipate the Cr-containing passivation layer present on the bonding surface more sufficiently and hence, the bonding strength of the united body can be further sufficiently enhanced.

(3) In the above-mentioned method of bonding steel members (1) or (2), it is preferable that the united body is gradually cooled to the third temperature under a condition that lowering of temperature to 600° C. from A₁ transformation point takes 15 hours or more.

By adopting such a method, it is possible to dissipate the Cr-containing passivation layer present on the bonding surface further sufficiently and hence, the bonding strength can be further sufficiently enhanced.

From this point of view, it is more preferable that the united body is gradually cooled to the third temperature under a condition that lowering of temperature to 600° C. from the A₁ transformation point takes 20 hours or more.

(4) In any one of the above-mentioned methods of bonding steel members (1) to (3), it is preferable that the third temperature is equal to or below 550° C.

By adopting such a method, the homogeneity of the united body can be enhanced and, at the same time, the hardness of the united body can be lowered thus enhancing the workability of the united body.

(5) In any one of the above-mentioned methods of bonding steel members (1) to (4), it is preferable that the united body is cooled in an inert gas atmosphere after finishing the bonding strength enhancing step.

By adopting such a method, it is possible to suppress the degradation of the quality of the united body attributed to oxidation of a surface of the united body in the cooling process.

(6) In any one of the above-mentioned methods of bonding steel members (1) to (5), it is preferable that the first temperature falls within a range from 1000° C. to 1100° C.

By adopting such a method, it is possible to form the united body by bonding a plurality of steel members while pressing the united body under a predetermined pressure condition.

(7) In any one of the above-mentioned methods of bonding steel members (1) to (6), it is preferable that the united body is gradually cooled after finishing the united body forming step.

By adopting such a method, it is possible to suppress the generation of stress strain in the united body attributed to pressurization and hence, the united body having high homogeneity can be formed.

(8) Any one of the above-mentioned methods of bonding steel members (1) to (7) may preferably further include a homogenizing step of heating the united body to a fourth temperature which makes the structure of the united body more homogeneous between the united body forming step and the bonding strength enhancing step.

By performing the homogenizing step between the united body forming step and the bonding strength enhancing step in the above-mentioned method of bonding steel members, it is possible to make the structure of the united body which is a non-homogeneous state due to the united body forming step more homogeneous and hence, the united body having higher homogeneity can be formed.

(9) In the above-mentioned method of bonding steel members (8), it is preferable that the fourth temperature falls within a range from 1000° C. to 1100° C.

By adopting such a method, it is possible to make the structure of the united body which is in a non-homogeneous state due to the united body forming step more homogeneous and hence, the united body having further higher homogeneity can be formed.

(10) In the above-mentioned method of bonding steel members according to the above-mentioned (8) or (9), it is preferable that the united body is rapidly cooled to a Ms point after finishing the homogenizing step and, thereafter, the united body is gradually cooled.

By adopting such a method, due to a quenching effect, the hardness of the united body can be increased and hence, it is possible to form a high-quality united body having a high strength.

(11) In any one of the above-mentioned methods of bonding steel members (1) to (10), it is preferable that the bonding scheduled surfaces of the plurality of steel members are formed in a planar shape.

By adopting such a method, it is possible to enhance a degree of contact between the steel members when the plurality of steel members are butted to each other after processing the bonding scheduled surfaces with high accuracy and hence, it is possible to provide a method of bonding steel members which enables the united body to acquire a phenomenon that a surface of the united body 10 is oxidized in the cooling process so that a quality of a product is degraded.

Further, according to the method of bonding steel members of the embodiment 1, the united body 10 is gradually cooled after finishing the united body forming step (S10) and hence, the generation of stress strain in the united body 10 attributed to applying of pressure to the united body 10 can be suppressed thus enabling the formation of the highly homogenous united body.

Further, according to the method of bonding steel members of the embodiment 1, between the united body forming step (S10) and the bonding strength enhancing step (S30), the homogenizing step (S20) which heats the united body 10 to the fourth temperature T₄ at which the structure of the united body 10 can be made more homogeneous is further provided. Accordingly, the structure of the united body 10 which is in a non-homogeneous state through the united body forming step (S10) can be made more homogeneous and hence, it is possible to obtain the more homogeneous united body 10.

Further, according to the method of bonding steel members of the embodiment 1, the united body 10 is rapidly cooled to the Ms point after finishing the homogenizing step (S20) and, thereafter, the united body 10 is gradually cooled. Accordingly, due to a quenching effect, hardness of the united body can be increased this leading to the formation of the high-quality united body having a high strength. sufficiently high bonding strength.

(12) In the above-mentioned method of bonding steel members (11), it is preferable that arithmetic average roughness Ra of the bonding scheduled surfaces is set to 0.2 μm or less.

By adopting such a method, it is possible to bond the plurality of steel members in a state that a distance between the bonding scheduled surfaces of the plurality of steel members is set to 0.4 μm or less on average and hence, the united body can acquire a sufficiently high bonding strength.

(13) In any one of the above-mentioned methods of bonding steel members (1) to (12), it is preferable that the united body forming step and the bonding strength enhancing step are performed in a vacuum or in an inert gas atmosphere.

By adopting such a method, it is possible to suppress the adverse influence attributed to the presence of the active gas such as oxygen in respective heat treatment steps.

(14) In any one of the above-mentioned methods of bonding steel members (1) to (13), when the steel material is hot-die steel, cold-die steel or martensite-based stainless steel, a particularly large advantage effect can be acquired.

Hot-die steel, cold-die steel or martensite-based stainless steel is Cr-containing steel and hence, in manufacturing the united body by bonding steel members made of such a steel material to each other, there may be a case that it is difficult for the united body to acquire a sufficiently high bonding strength. To the contrary, according to the method of bonding steel members of the present invention, even when the steel members are made of such a steel material, the steel members can be bonded to each other with a sufficiently high bonding strength.

(15) In any one of the above-mentioned methods of bonding steel members (1) to (14), it is preferable that the plurality of steel members is heated by magnetic heating in the united body forming step.

Here, in the method of bonding steel members of the present invention, the united body forming step may be also performed by heating from the outside or by electric heating. However, by performing the united body forming step by magnetic heating, it is possible to heat the plurality of steel members at a high speed and uniformly and hence, it is possible to manufacture a high-quality united body having small stress strain with high productivity.

(16) In any one of the above-mentioned methods of bonding steel members (1) to (15), it is preferable that the plurality of steel members is pressed using a servo motor in the united body forming step.

By adopting such a method, it is possible to press the plurality of steel members under a fixed pressure condition and hence, it is possible to manufacture a high-quality united body having small stress strain.

(17) A method of enhancing a bonding strength of a united body formed of steel members of the present invention is characterized in that the united body is formed by bonding a plurality of steel members made of a Cr-containing steel material to each other, is heated to a temperature equal to or above the A₁ transformation point of the steel material and, thereafter, is gradually cooled to a temperature equal to or below 600° C. under a condition that lowering temperature to 600° C. from the A₁ transformation point takes 10 hours or more thus dissipating a Cr-containing passivation layer present on bonding surfaces of the united body whereby a bonding strength of the united body can be enhanced.

In this manner, according to the method of enhancing a bonding strength of a united body formed of steel members of the present invention, it is possible to provide a method of enhancing a bonding strength of a united body formed of steel members in which, by sufficiently enhancing the bonding strength of the united body by dissipating the Cr-containing passivation layer present on the bonding surface, even when the united body is formed by bonding the plurality of steel members made of Cr-containing steel material to each other, the united body can acquire a sufficiently high bonding strength.

(18) A steel product of the present invention is a steel product which is manufactured using the united body formed by bonding steel members using any one of the above-mentioned methods of bonding steel members (1) to (16) or using the united body whose bonding strength is enhanced by the method of enhancing a bonding strength of a united body formed of steel members according to the above-mentioned (17).

In this manner, the steel product of the present invention becomes a steel product formed of steel members which are bonded to each other with a sufficiently high bonding strength and hence, the steel product can be used in various applications.

As the steel product, various forming molds, various tools, various structural members and the like can be used.

(19) In the above-mentioned steel product (18), it is preferable that a portion of the united body which exposes to the outside from the bonding surface by at least 2 mm is removed.

Due to such constitution, it is possible to obtain a high quality steel product from which a peripheral portion having a relatively small bonding strength is removed.

(20) The above-mentioned steel product (18) or (19) can acquire a particularly large advantage effect when the steel product is a die-cast mold.

The die-cast mold of the present invention is a die-cast mold manufactured using the united body and hence, the die-cast mold enables the easy manufacture of a die-cast mold having complicated structure such as a die-cast mold which forms a heat exchange medium flow passage therein. Further, since the steel members of the die-cast mold of the present invention are bonded to each other with a sufficiently high bonding strength, it is possible to manufacture a die-cast mold having high reliability and a long lifetime.

(21) A die-cast product of the present invention is a die-cast product which is manufactured using the above-mentioned die-cast mold (20).

In this manner, the die-cast product according to the present invention is a die-cast product manufactured using a die-cast mold having high reliability and a long lifetime which enables the easy manufacture of the die-cast mold having the complicated structure as described above and hence, the die-cast product having high quality can be manufactured at a low cost.

(22) A method of bonding steel members according to the present invention is a method of bonding steel members for bonding a plurality of steel members made of a steel material to each other, the method includes a united body forming step in which bonding scheduled surfaces of the plurality of steel members are butted to each other, and the plurality of steel members are heated to a temperature which enables bonding of the plurality of steel members to each other by magnetic heating while pressing the plurality of steel members under a predetermined pressure condition thus forming a united body by bonding the plurality of steel members.

According to the method of bonding steel members of the present invention, the plurality of steel members are heated by magnetic heating in the united body forming step and hence, it is possible to heat the plurality of steel members at a high speed and uniformly leading to the manufacture of the united body of high quality having small stress strain with high productivity.

(23) In a method of bonding steel members for bonding a plurality of steel members made of a steel material to each other, the method includes a united body forming step in which bonding scheduled surfaces of a plurality of steel members are butted to each other, and the plurality of steel members are heated to a temperature which enables bonding of the plurality of steel members to each other while pressing the plurality of steel members under a predetermined pressure condition using a servo motor thus forming a united body by bonding the plurality of steel members.

According to the method of bonding steel members of the present invention, the plurality of steel members are pressed using the servo motor in the united body forming step and hence, it is possible to press the plurality of steel members under a predetermined pressure condition whereby it is possible to manufacture the high-quality united body with small stress strain.

### BRIEF EXPLANATION OF DRAWINGS

FIG. 1 is a flowchart for explaining a method of bonding steel members according to an embodiment 1;

FIG. 2 is a view for explaining the method of bonding steel members according to the embodiment 1;

FIG. 3(a) to FIG. 3(d) are views for explaining the method of bonding steel members according to the embodiment 1;

FIG. 4(a) and FIG. 4(b) are cross-sectional electron microscope photographs of a bonded portion of a united body;

FIG. 5(a) to FIG. 5(d) are views for explaining a method of bonding steel members according to an embodiment 2;

FIG. 6(a) to FIG. 6(e) are views for explaining a method of bonding steel members according to an embodiment 3;

FIG. 7 is a flowchart for explaining a conventional method of bonding steel members; and

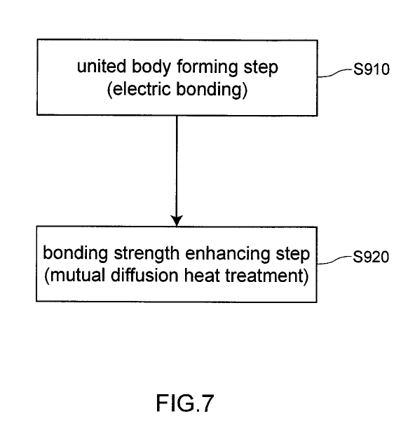

FIG. 8 is a view for explaining the conventional method of bonding steel members.

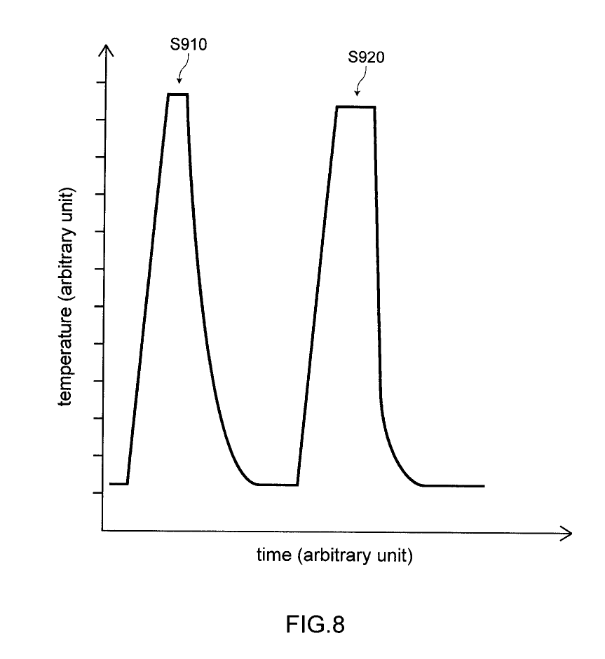

### BEST MODE FOR CARRYING OUT THE INVENTION

Hereinafter, the explanation is made with respect to a method of bonding steel members, a method of enhancing a bonding strength of a united body formed of steel members, a steel product, and a die-cast product of the present invention in conjunction with embodiments shown in the drawings.

### Embodiment 1

An embodiment 1 is an embodiment for explaining a method of bonding steel members of the present invention.

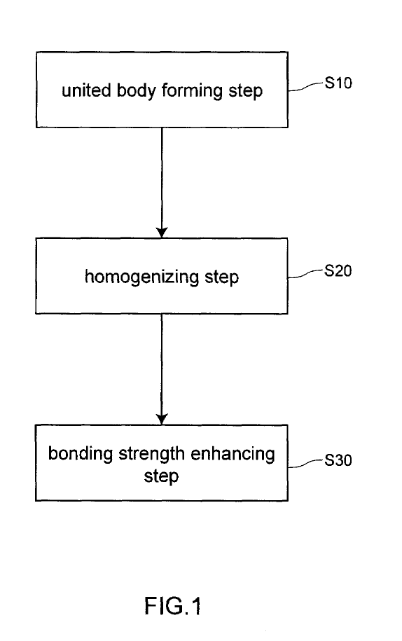

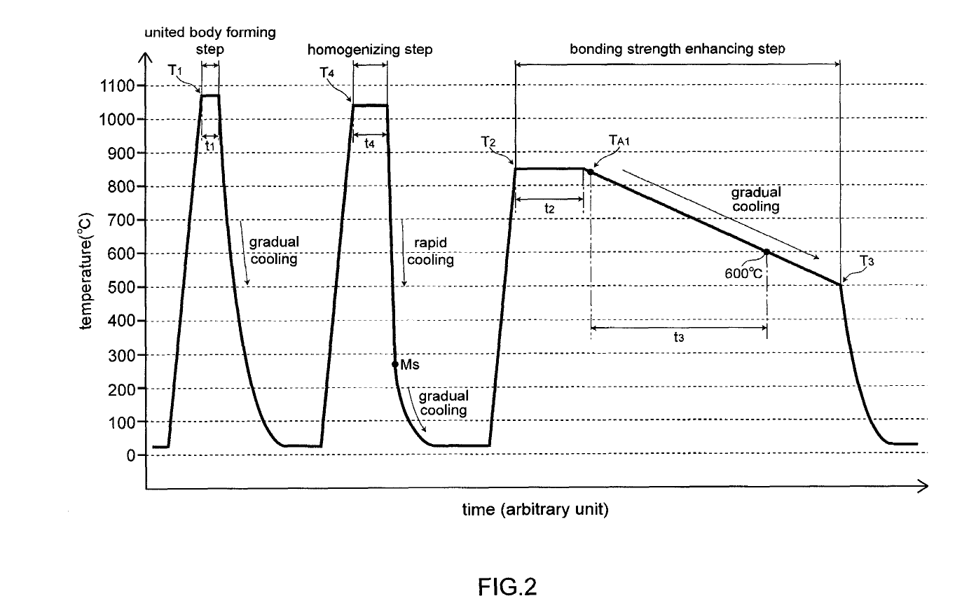

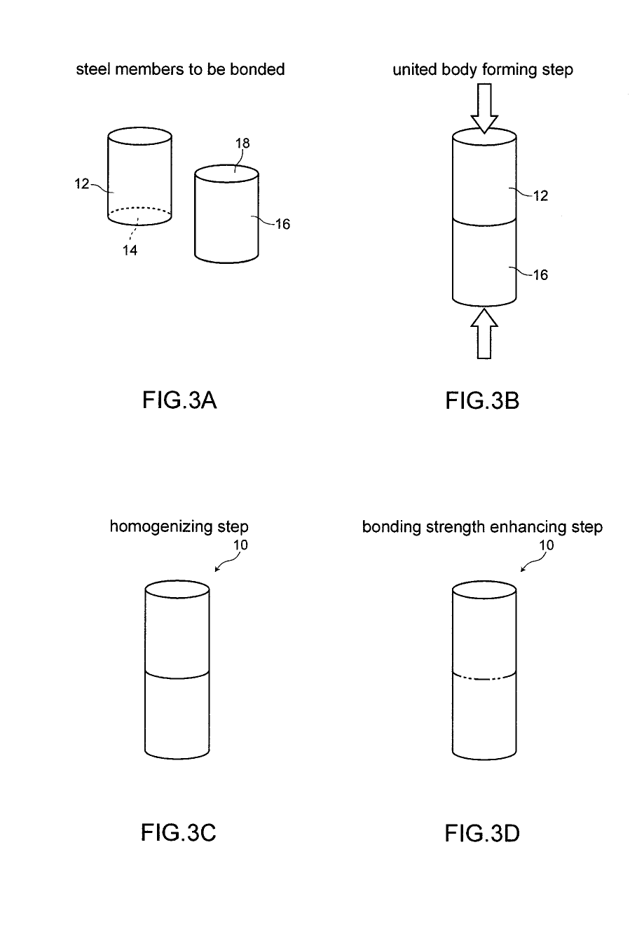

FIG. 1 is a flowchart for explaining a method of bonding steel members according to the embodiment 1. FIG. 2 is a view for explaining the method of bonding steel members according to the embodiment 1. In FIG. 2, time is taken on an axis of abscissas and temperature is taken on an axis of ordinates. FIG. 3(a) to FIG. 3(d) are views for explaining the method of bonding steel members according to the embodiment 1. FIG. 3(a) is a view showing steel members 12, 16 which are scheduled to be bonded, FIG. 3(b) is a view showing the steel members 12, 16 in a united body forming step (S10), FIG. 3(c) is a view showing a united body 10 after finishing a homogenizing step (S20), and FIG. 3(d) is a view showing the united body 10 after finishing a bonding strength enhancing step (S30).

The method of bonding steel members according to the embodiment 1 is substantially a method of bonding steel members by bonding a plurality of steel members made of a Cr-containing steel material to each other. The method of bonding steel members according to the embodiment 1 includes, as shown in FIG. 1, the united body forming step (S10), the homogenizing step (S20) and the bonding strength enhancing step (S30) in this order.

The united body forming step (S10) is a step in which, as shown in FIG. 2 and FIG. 3(b), bonding scheduled surfaces 14, 18 of two steel members 12, 16 are butted to each other, two steel members 12, 16 are heated to a first temperature T₁ (for example, 1000 to 1100° C. (1070° C. in FIG. 2)) at which two steel members 12, 16 are bondable to each other while pressing two steel members 12, 16 under a predetermined pressure condition thus bonding two steel members 12, 16 to form a united body 10.

In the united body forming step (S10), the pressing is performed using oil pressure, and is performed at a pressure of 10 MPa, for example. In the united body forming step (S10), heating is performed in a vacuum furnace and a holding time at the first temperature T₁ is set to 30 minutes (see t₁ in FIG. 2). After finishing the united body forming step (S10), the united body 10 is gradually cooled to a room temperature.

The homogenizing step (S20) is a step in which, as shown in FIG. 2, the united body 10 is heated to a fourth temperature T₄ (for example, 1000 to 1100° C. (1040° C. in FIG. 2)) at which the structure of the united body 10 can be made more homogeneous.

The holding time at the fourth temperature T₄ is set to 1 hour (see t₄ in FIG. 2). After finishing the homogenizing step (S20), the united body 10 is rapidly cooled to an Ms point and, thereafter, the united body 10 is gradually cooled.

The bonding strength enhancing step (S30) is a step in which, as shown in FIG. 2, the united body 10 is heated to a second temperature T₂ (850° C. in FIG. 2) which is equal to or above an A₁ transformation point T_{A1} of a steel material and, subsequently, the united body 10 is gradually cooled to a third temperature T₃ (500° C. in FIG. 2) which is equal to or below 600° C. under a condition that lowering of temperature to 600° C. from the A1 transformation point T_{A1} takes 10 hours or more thus dissipating a Cr containing passivation layer present on bonding surface of the united body 10 whereby a bonding strength of the united body 10 is enhanced.

In the bonding strength enhancing step (S30), heating is performed in a vacuum furnace and a holding time at a second temperature T₂ is set to 2 hours (see t₂ in FIG. 2). After finishing the bonding strength enhancing step (S30), the united body 10 is cooled in an inert gas atmosphere (for example, in an N₂ gas atmosphere).

In the method of bonding steel members according to the embodiment 1, as the steel member, the steel members 12, 16 which are made of a hot-die steel (SKD 61) are used. The steel members 12, 16 have, as shown in FIG. 3(a), cylindrical shapes (φ20 mm×20 mm). Bonding scheduled surfaces 14, 18 of the steel members 12, 16 have a planar shape. Further, arithmetic average roughness of the bonding scheduled surfaces 14, 18 of the steel members 12, 16 are set to 0.1 μm.

According to the method of bonding steel members of the embodiment 1 which includes the above-mentioned steps, by performing the above-mentioned bonding strength enhancing step (S30) after the united body forming step (S10), the Cr-containing passivation layer present on the bonding surface can be dissipated so that a bonding strength can be sufficiently increased. As a result, the method of bonding steel members according to the embodiment 1, even when the united body is manufactured by bonding the plurality of steel members made of the Cr-containing steel material to each other, becomes a method of bonding steel members which enables the united body to acquire a sufficiently high bonding strength.

In the method of bonding steel members according to the embodiment 1, for acquiring a sufficiently high bonding strength by dissipating the Cr-containing passivation layer present on the bonding surface, the united body 10 is heated to the second temperature equal to or above the A₁ transformation point T_{A1} of the steel material and, subsequently, the united body 10 is gradually cooled to the third temperature T₃ which is equal to or below 600° C. under a condition that lowering of temperature to 600° C. from the A₁ transformation point T_{A1} takes 10 hours or more. That is, the united body is gradually cooled spending a sufficient time within a temperature range from the A₁ transformation point T_{A1} to 600° C.

In this manner, according to the method of bonding steel members of the embodiment 1, the Cr-containing passivation layer present on the bonding surface is melted in the steel material which constitutes a mother phase in the course of the transformation of structure along with the gradual cooling, and the Cr-containing passivation layer is finally dissipated and hence, the bonding strength of the united body can be sufficiently enhanced.

Further, according to the method of bonding steel members of the embodiment 1, the united body 10 is cooled in an inert gas atmosphere (for example, in an N₂ gas atmosphere) after finishing the bonding strength enhancing step (S30) and hence, it is possible to prevent a

Further, according to the method of bonding steel members of the embodiment 1, the bonding scheduled surfaces 14, 18 of the steel members 12, 16 are formed in a planar shape and hence, by forming the bonding scheduled surfaces with high accuracy, a degree of contact between the steel members when the steel members are butted to each other can be enhanced thus enabling the acquisition of a sufficiently high bonding strength.

Further, according to the method of bonding steel members of the embodiment 1, the arithmetic average roughness Ra of the bonding scheduled surfaces 14, 18 is set to 0.2 μm or less and hence, the steel members 12, 16 can be bonded to each other in a state that a distance between the bonding scheduled surfaces 14, 18 of the steel members 12, 16 is set to 0.4 μm or less on average and hence, the united body 10 can acquire a sufficiently high bonding strength.

Further, according to the method of bonding steel members of the embodiment 1, the united body forming step (S10) and the bonding strength enhancing step (S30) are performed in a vacuum and hence, adverse influences which may occur attributed to the presence of an active gas such as oxygen in each heat treatment step can be suppressed.

Further, according to the method of bonding steel members of the embodiment 1, the united body 10 is manufactured by bonding the steel members made of a Cr-containing hot-die steel material (SKD61 of JIS, for example) to each other, the steel members can be bonded to each other with a high bonding strength also in such a case.

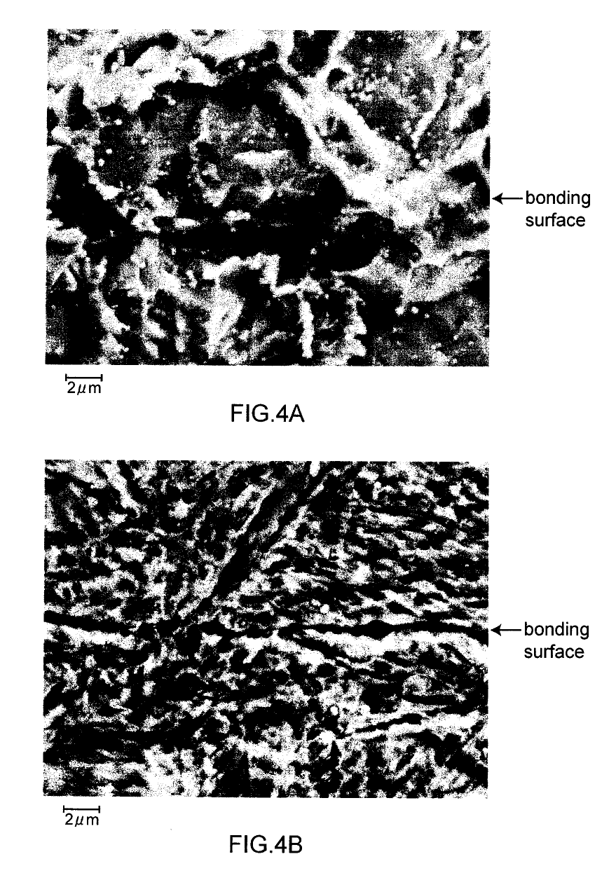

FIG. 4 (a) and FIG. 4(b) are cross-sectional electron microscope photographs of a bonded portion of the united body. FIG. 4(a) is the cross-sectional electron microscope photograph of the bonded portion of the united body 10 formed by bonding the steel members using the method of bonding steel members of the embodiment 1, and FIG. 4(b) is the cross-sectional electron microscope photograph of the bonded portion of a united body (not shown in the drawing) formed by bonding steel members using a method of bonding steel members of a comparison example 1.

The method of bonding steel members of the comparison example 1 is a method of bonding steel members which is substantially equal to the method of bonding steel members of the embodiment 1. However, the method of bonding steel members of the comparison example 1 differs from the method of bonding steel members of the embodiment 1 with respect to a point that the method of bonding steel members of the comparison example 1 does not include the bonding strength enhancing step (S30) after the united body forming step (S10) (and the homogenizing step (S20)).

As can be clearly understood from FIG. 4, in the united body which is formed by bonding steel members using the method of bonding steel members of the comparison example 1, a bonding surface is clearly observed. To the contrary, in the united body 10 which is formed by bonding steel members using the method of bonding steel members of the embodiment 1, no bonding surface is observed.

In this manner, according to the method of bonding steel members of the embodiment 1, by performing the above-mentioned bonding strength enhancing step (S30) after the united body forming step (S10), the Cr-containing passivation layer present on the bonding surface can be dissipated and hence, a bonding strength of the united body 10 can be sufficiently increased. As a result, the method of bonding steel members of the embodiment 1 becomes a method of bonding steel members which enables the united body 10 to acquire a sufficiently high bonding strength even when a united body is manufactured by bonding a plurality of steel members made of a Cr-containing steel material.

### Embodiment 2

An embodiment 2 is an embodiment provided for explaining a method of bonding steel members of the present invention and a steel product which is manufactured by the method. The explanation is made with respect to an example in which a pressurizing pin used for manufacturing a die-cast mold is adopted as the steel product.

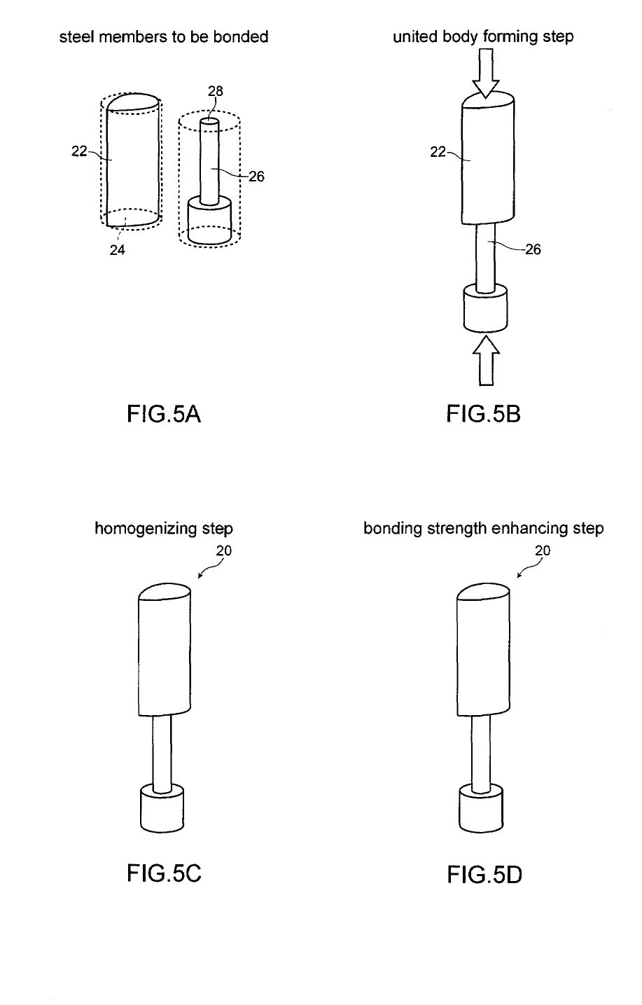

FIG. 5(a) to FIG. 5(d) are views for explaining a method of bonding steel members according to the embodiment 2. FIG. 5(a) is a view showing steel members 22, 26 which are scheduled to be bonded, FIG. 5(b) is a view showing the steel members 22, 26 in a united body forming step (S10), FIG. 5(c) is a view showing a united body 20 after finishing a homogenizing step (S20), and FIG. 5(d) is a view showing the united body 20 after finishing a bonding strength enhancing step (S30).

Although the method of bonding steel members according to the embodiment 2 is substantially equal to the method of bonding steel members according to the embodiment 1, the method of bonding steel members according to the embodiment 2 differs from the method of bonding steel members according to the embodiment 1 with respect to an object to be bonded. That is, in the method of bonding steel members according to the embodiment 2, as shown in FIG. 5(a), as the object to be bonded, the steel members 22, 26 which are cut into a predetermined shape by NC cutting forming are used. In the same manner as the method of bonding steel members according to the embodiment 1, hot die steel (SKD 61) is used as a steel material.

In this manner, the method of bonding steel members according to the embodiment 2 differs from the method of bonding steel members according to the embodiment 1 with respect to the object to be bonded. However, in the same manner as the method of bonding steel members according to the embodiment 1, the above-mentioned bonding strength enhancing step (S30) is performed after the united body forming step (S10) and hence, the Cr-containing passivation layer present on the bonding surface can be dissipated whereby a bonding strength can be sufficiently increased. As a result, the method of bonding steel members according to the embodiment 2 becomes a method of bonding steel members which enables the united body to acquire a sufficiently high bonding strength even when a united body is manufactured by bonding a plurality of steel members made of a Cr-containing steel material.

Accordingly, even when the steel product is manufactured using the united body forming step in which a plurality of steel members are bonded to each other for easily manufacturing a steel product having a relatively complicated shape such as the pressurizing pin (forming of the steel product using a single steel material as a starting material being not easy), the steel product can acquire the sufficiently high bonding strength and hence, it is possible to manufacture a steel product which can be used in various applications.

### Embodiment 3

An embodiment 3 is an embodiment provided for explaining a method of bonding steel members of the present invention and a steel product which is manufactured by the method. The explanation is made with respect to an example in which a die-cast mold is adopted as the steel product.

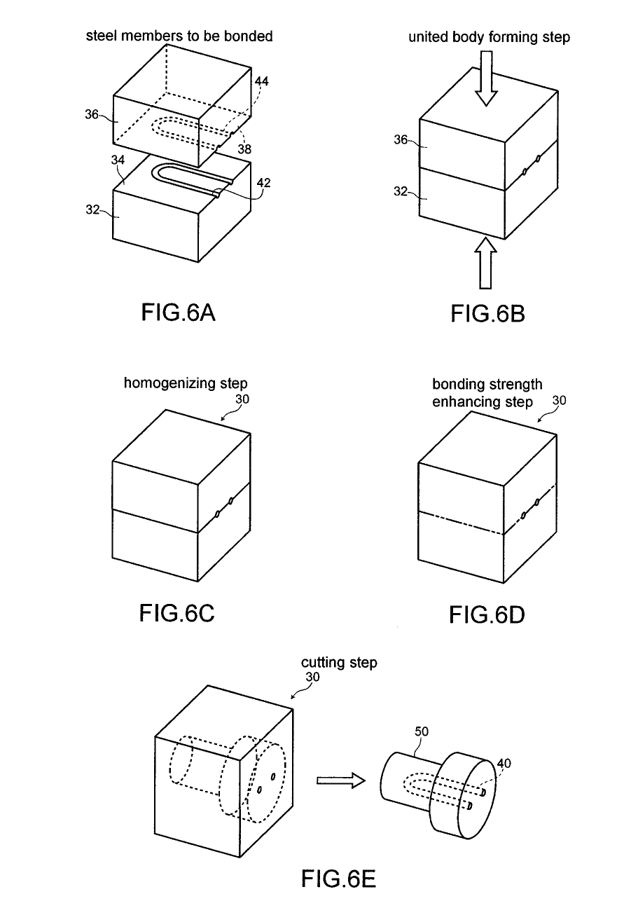

FIG. 6(a) to FIG. 6(e) are views for explaining a method of bonding steel members according to the embodiment 3. FIG. 6(a) is a view showing steel members 32, 36 which are scheduled to be bonded, FIG. 6(b) is a view showing the steel members 32, 36 in a united body forming step (S10), FIG. 6(c) is a view showing a united body 30 after finishing a homogenizing step (S20), FIG. 6(d) is a view showing the united body 30 after finishing a bonding strength enhancing step (S30), and FIG. 6(e) is a view showing a cutting step after finishing the bonding strength enhancing step (S30).

Although the method of bonding steel members according to the embodiment 3 is substantially equal to the method of bonding steel members according to the embodiment 1, the method of bonding steel members according to the embodiment 3 differs from the method of bonding steel members according to the embodiment 1 with respect to an object to be bonded. That is, in the method of bonding steel members according to the embodiment 3, as shown in FIG. 6(a), as the object to be bonded, the steel members 32, 36 which form heat exchange medium flow passage forming grooves 42, 44 on bonding scheduled surfaces thereof are used. In the same manner as the method of bonding steel members according to the embodiment 1, hot die steel (SKD 61) is used as a steel material.

In this manner, the method of bonding steel members according to the embodiment 3 differs from the method of bonding steel members according to the embodiment 1 with respect to the object to be bonded. However, in the same manner as the method of bonding steel members according to the embodiment 1, the above-mentioned bonding strength enhancing step (S30) is performed after the united body forming step (S10) and hence, the Cr-containing passivation layer present on the bonding surface can be dissipated whereby a bonding strength can be sufficiently increased. As a result, the method of bonding steel members of the embodiment 3 becomes a method of bonding steel members which enables the united body to acquire a sufficiently high bonding strength even when a united body is manufactured by bonding a plurality of steel members made of a Cr-containing steel material.

Accordingly, even when the steel product is manufactured using a united body forming step in which a plurality of steel members are bonded to each other for easily manufacturing a steel product having a relatively complicated shape such as the die-cast mold (forming of the steel product using a single steel material as a starting material being almost impossible), the steel product can acquire the sufficiently high bonding strength and hence, it is possible to manufacture a die-cast mold which can be used in various applications.

In the method of bonding steel members according to the embodiment 3, as shown in FIG. 6(e), cutting forming is applied to the united body 30 which is formed by bonding steel members 32, 36 so as to form the united body 30 into a desired shape. In this manner, it is possible to manufacture a die-cast mold 50 having a heat exchange medium flow passage 40 in the inside of the mold 50.

In this manner, in the die-cast mold 50 according to the embodiment 3, the steel members are bonded to each other with a sufficiently high bonding strength and hence, it is possible to manufacture the die-cast mold 50 which exhibits high reliability and prolonged lifetime (being confirmed that the lifetime is prolonged 100 times or more compared to a conventional die-cast mold according to an experiment). Accordingly, a die-cast product manufactured using a die-cast mold 50 becomes a die-cast product of high quality which can be manufactured at a low cost.

Here, in the method of bonding steel members according to the embodiment 3, a portion of the united body 30 which is within at least 2 mm from a bonding surface exposed to the outside is removed. By adopting such a method, it is possible to manufacture a high-quality die-cast mold from which the peripheral portion which exhibits a relatively low bonding strength is removed.

Although the method of bonding steel members, the steel product and the die-cast product according to the present invention have been explained in conjunction with the above-mentioned respective embodiments, the present invention is not limited to the above-mentioned respective embodiments and is carried out in various modes without departing from the gist of the present invention, and following modifications are conceivable, for example.

(1) In the above-mentioned respective embodiments, the explanation has been made with respect to the method of bonding steel members which includes the united body forming step (S10), the homogenizing step (S20) and the bonding strength enhancing step (S30) in this order. However, the present invention is not limited to such a method of bonding steel members. That is, the present invention also includes a method of enhancing a bonding strength of a united body formed of steel members being, wherein the united body which is formed by bonding a plurality of steel members made of a Cr-containing steel material to each other is heated to a temperature equal to or above an A₁ transformation point T_{A1} of the steel material and, thereafter, the united body is gradually cooled to a temperature equal to or below 600° C. under a condition that lowering temperature to 600° C. from the A₁ transformation point T_{A1} takes 10 hours or more thus dissipating a Cr-containing passivation layer present on bonding surfaces of the united body whereby a bonding strength of the united body is enhanced. Also in this case, the united body can acquire a sufficiently high bonding strength even when the united body is manufactured by bonding the plurality of steel members made of a Cr-containing steel material to each other.

(2) In the above-mentioned respective embodiments, the united body forming step (S10), the homogenizing step (S20) and the bonding strength enhancing step (S30) are performed in a vacuum. However, the present invention is not limited to such a case. For example, these steps may be performed in an inert gas atmosphere such as an N₂ gas or an Ar gas. Also with such a method, it is possible to suppress the adverse influence attributed to an active gas such as oxygen in respective heat treatment steps (S10 to S30).

(3) In the above-mentioned respective embodiments, the united body forming step (S10) is performed by external heating using a vacuum furnace. However, the present invention is not limited such united body forming step (S10). For example, the united body forming step (S10) may be performed by external heating which uses a heating furnace other than the vacuum furnace, electric heating or magnetic heating. Out of these heating, in magnetic heating, it is possible to heat a plurality of steel member at a high speed and uniformly leading to the manufacture of united bodies of high quality with small stress strain with high productivity.

Here, the method of performing the united body forming step (S10) by magnetic heating is also applicable to the method of bonding steel members by bonding the plurality of steel members made of a steel material containing no Cr to each other.

(4) In the above-mentioned respective embodiments, the plurality of steel members is heated while being pressed by an oil pressure. However, the present invention is not limited to such heating. For example, the plurality of steel members may be heated while being pressed under a predetermined pressure condition using a servo motor. In this case, it is possible to press the plurality of steel members under a fixed pressure condition leading to the manufacture of united bodies of high quality with small stress strains.

Here, the method which presses the steel members using the servo motor in the united body forming step (S10) is also applicable to the method of bonding a plurality of steel members made of a steel material containing no Cr to each other.

(5) In the above-mentioned respective embodiments, the united body is gradually cooled under the condition that lowering of temperature to 600° C. from the A₁ transformation point T_{A1} takes 10 hours or more in the bonding strength enhancing step (S30). However, the present invention is not limited to such cooling. For example, the united body may be gradually cooled under a condition that lowering of temperature to 600° C. from the A₁ transformation point T_{A1} takes 15 hours or more or 20 hours or more. Due to such cooling, it is possible to further sufficiently dissipate the Cr-containing passivation layer present on bonding surfaces thus further enhancing the bonding strength of the united body.

(6) In the above-mentioned respective embodiments, the explanation has been made with respect to the case in which the bonding scheduled surfaces 14, 18, 24, 28, 34, 38 are formed in a planar shape. However, the present invention is not limited to such a case. That is, provided that the bonding scheduled surfaces can be brought into close contact with each other, the bonding scheduled surfaces may be formed in a curved shape or may have steps.

(7) In the above-mentioned respective embodiments, hot-die steel (SKD61) is used as the steel material. However, the present invention is not limited to hot-die steel (SKD61). For example, hot-die steel beside hot-die steel (SKD61), cold die steel, high speed cutting-tool steel or martensite-based stainless steel can be also used. Also with the use of these steel members made of a steel material, it is possible to bond the steel members with a sufficiently high bonding strength.

(8) In the above-mentioned respective embodiments, the cylindrical united body, the pressurizing pin or the die-cast mold is manufactured as the steel product. However, the steel product is not limited to these products. That is, as other steel products, various forming molds, various tools or various structural materials may be used.

### DESCRIPTION OF THE REFERENCE NUMERALS AND SIGNS

10, 20, 30: united body
12, 16, 22, 26, 32, 36: steel member
14, 18, 24, 28, 34, 38: bonding scheduled surface
40: heat exchange medium flow passage
42, 44: heat exchange medium flow passage forming groove
50: die-cast mold
S10, S910: united body forming step
S20: homogenizing step
S30, S920: bonding strength enhancing step
T₁: first temperature
T₂: second temperature
T₃: third temperature
T₄: fourth temperature
T_{A1}: A₁ transformation point
t₁: first heat treatment time
t₂: second heat treatment time
t₃: third heat treatment time
t₄: fourth heat treatment time

1. A method of bonding steel members by bonding a plurality of steel members made of a Cr-containing steel material, the method comprising;
a united body forming step in which a united body is formed by bonding a plurality of steel members to each other such that bonding scheduled surfaces of the plurality of steel members are butted to each other, and the plurality of steel members are heated to a first temperature which enables bonding of the plurality of steel members while pressing the plurality of steel members under a predetermined pressure condition; and
a bonding strength enhancing step in which the bonding strength of the united body is enhanced by heating the united body to a second temperature equal to or above an A₁ transformation point of the steel material and, subsequently, by gradually cooling the united body to a third temperature equal to or below 600° C. under a condition that lowering of temperature to 600° C. from A₁ transformation point takes 10 hours or more thus dissipating a Cr-containing passivation layer present on bonding surfaces of the united body in this order.

2. A method of bonding steel members according to claim 1, wherein the second temperature falls within a range between the A₁ transformation point and a temperature higher than the A₁ transformation point by 100° C.

3. A method of bonding steel members according to claim 1, wherein the united body is gradually cooled to the third temperature under a condition that lowering of temperature to 600° C. from A₁ transformation point takes 15 hours or more.

4. A method of bonding steel members according to claim 1, wherein the third temperature is equal to or below 550° C.

5. A method of bonding steel members according to claim 1, wherein the united body is cooled in an inert gas atmosphere after finishing the bonding strength enhancing step.

6. A method of bonding steel members according to claim 1, wherein the first temperature falls within a range from 1000° C. to 1100° C.

7. A method of bonding steel members according to claim 1, wherein the united body is gradually cooled after finishing the united body forming step.

8. A method of bonding steel members according to claim 1, further comprising a homogenizing step of heating the united body to a fourth temperature which makes the structure of the united body more homogeneous between the united body forming step and the bonding strength enhancing step.

9. A method of bonding steel members according to claim 8, wherein the fourth temperature falls within a range from 1000° C. to 1100° C.

10. A method of bonding steel members according to claim 8, wherein the united body is rapidly cooled to a Ms point after finishing the homogenizing step and, thereafter, the united body is gradually cooled.

11. A method of bonding steel members according to claim 1, wherein the bonding scheduled surfaces of the plurality of steel members are formed in a planar shape.

12. A method of bonding steel members according to claim 11, wherein arithmetic average roughness Ra of the bonding scheduled surfaces is set to 0.2 μm or less.

13. A method of bonding steel members according to claim 1, wherein the united body forming step and the bonding strength enhancing step are performed in a vacuum or in an inert gas atmosphere.

14. A method of bonding steel members according to claim 1, wherein the steel material is a hot-die steel, cold-die steel or martensite-based stainless steel.

15. A method of bonding steel members according to claim 1, wherein the plurality of steel members is heated by magnetic heating in the united body forming step.

16. A method of bonding steel members according to claim 1, wherein the plurality of steel members is pressed using a servo motor in the united body forming step.

17. A method of enhancing a bonding strength of a united body formed of steel members being characterized in that the united body is formed by bonding a plurality of steel members made of a Cr-containing steel material to each other, is heated to a temperature equal to or above the A₁ transformation point of the steel material and, thereafter, is gradually cooled to a temperature equal to or below 600° C. under a condition that lowering temperature to 600° C. from the A₁ transformation point takes 10 hours or more thus dissipating a Cr-containing passivation layer present on bonding surfaces of the united body whereby a bonding strength of the united body is enhanced.

18. A steel product manufactured using the united body formed by bonding steel members using the method of bonding steel members according to claim 1 or the united body whose bonding strength is enhanced by the method of enhancing a bonding strength of a united body formed of steel members.

19. A steel product according to claim 18, wherein a portion of the united body which exposes to the outside from the bonding surface by at least 2 mm is removed.

20. A steel product according to claim 18, wherein the steel product is a die-cast mold.

21. A die-cast product manufactured using the die-cast mold according to claim 20.

22. A method of bonding steel members for bonding a plurality of steel members made of a steel material to each other, the method including a united body forming step in which bonding scheduled surfaces of a plurality of steel members are butted to each other, and the plurality of steel members are heated to a temperature which enables bonding of the plurality of steel members to each other by magnetic heating while pressing the plurality of steel members under a predetermined pressure condition thus forming a united body by bonding the plurality of steel members.

23. A method of bonding steel members for bonding a plurality of steel members made of a steel material to each other, the method including a united body forming step in which bonding scheduled surfaces of a plurality of steel members are butted to each other, and the plurality of steel members are heated to a temperature which enables bonding of the plurality of steel members to each other while pressing the plurality of steel members under a predetermined pressure condition using a servo motor thus forming a united body by bonding the plurality of steel members.
